(19) United States
(12) Patent Application Publication
(10) Pub. No.: US 2007/0148282 A1
(43) Pub. Date: Jun. 28, 2007

(54) Performance Oral Snack

(75) Inventors: Kasim A. Zubair, Brampton (CA); Tiffany L. Bierer, Brentwood, TN (US); Liisa Mooney, Toronto (CA); Allan A. Torney, Brampton (CA); Yijun Wang, Etobicoke (CA)

Correspondence Address: Fulbright & Jaworski L.L.P., Fulbright Tower, 1301 McKinney, Suite 5100, Houston, TX, 77010-3095, US

(73) Assignee: Mars, Inc.

(21) Appl. No.: 11/566,019

(22) Filed: Dec. 1, 2006

Related U.S. Application Data
(60) Provisional application No. 60/742,081, filed on Dec. 2, 2005.

(51) Int. Cl. A23K 1/18

(52) U.S. Cl. 426/2

(57) ABSTRACT

The present invention relates to a canine dental chew composition comprising a protein source material, a scrubber, moisture; and humectant and having a specific disintegration and hardness properties which ensure dental care clinical efficacy, high safety, high palatability and is nutritionally complete and balanced.

### CROSS-REFERENCE TO RELATED APPLICATIONS

This application claims priority to U.S. provisional application Ser. No. 60/742,081, filed Dec. 2, 2005.

### TECHNICAL FIELD

The following invention relates to a dental chew, particularly a canine dental chew, designed to ensure dental care clinical efficacy, have high product safety, have high palatability and be nutritionally complete and balanced.

### BACKGROUND OF THE INVENTION

There has been a proliferation of dental chews for pets in the market, particularly those designed to address oral care problems. The majority of these products are based on hard textures that require repeated chewing for efficacy. There is ample published literature to support the use of dogs chew of various textures to reduce build up of tartar (Gorrel and Rawlings, 1996; Rawlings et al., 1998; Gorrel and Bierer; 1999; Gorrel et al., 1999 and Lage at al., 1990).

The prior art is replete with different types of processed pet foods. For example, extruded dog foods have been a staple for many years, and a bewildering number of recipes and preparation methods have been disclosed. In physical forms, extruded dog foods have included moist, semi-moist and dried kibble-type feeds.

U.S. Pat. No. 4,284,652 discloses producing a matrix from which is formed a soft, dry pet food product. The matrix comprises starch, fat, polyhydric alcohol and water and results in a soft, pliable, and stretchable composition. The final pet food product will likely include amounts of protein and other nutritional ingredients. However, because of its soft, pliable nature, the product is intended for immediate consumption and is not suitable for forming a long-lasting dog chew.

Notwithstanding the existence of voluminous prior art in the pet food area, there is a notable lack of any references dealing with or describing long-lasting dog chew products. Furthermore, typical extruded dog feeds are designed for immediate consumption by an animal, rather than over an extended period.

Rawhide and pig ear products are commonly known in the art and provide desirable dog chewing properties. However, these products can cause concerns regarding digestibility should the dog swallow a large portion of the chew.

Within the prior art there exists a number of starch based injection molded chew products having various shapes and designs. These products are generally brittle and tend to become slimy when contacted with water. Furthermore, these starch based products tend to dissolve in the dog's saliva thereby presenting a staining problem should the dog consume the chew indoors in the vicinity of carpet and upholstery. Starch-based chew products are prone to crumble and fragment into small pieces which are not effective in dental cleaning.

Protein based injection molded products, particularly wheat gluten based products, exhibit several desirable chew treat properties. Protein based dog chews can be made ductile with proper packaging, are non-staining, are non-greasy and do not exhibit microbial concerns. However, protein based products are more expensive to produce because of the protein content and production process employed. Some protein-based chew products are prone to fracture into large pieces or to be brittle and break into large sharp pieces. In many cases they pose risks to dogs either from physical injury such as gum injury, or tooth fracture.

Other dental chews are made with non-food materials such as thermoplastic polymers that offer no nutritional benefits to dogs. The associated safety risks include blockage of the digestive system since they are not digestible, and in extreme situations may require surgical intervention to correct.

Yet other prior art dog chews are touted as being long-lasting, such as those disclosed by Nie et al. in U.S. Published Patent Applications 2004/0086616 A1; 2004/0197455 A1; and 2005/0008758 A1. These starch- and protein-based dog chews are purported to be long-lasting and inexpensive, but are not efficacious in maintaining the dental health of dogs.

The dental chew provided herein, ensures clinical efficacy for oral care, have high product safety, have surprisingly high palatability and are nutritionally complete and balanced. The dental chew described herein disintegrates into a profile of piece sizes that are useful for tooth cleaning.

### BRIEF SUMMARY OF THE INVENTION

In one aspect of the present invention, there is canine dental chew composition comprising 25%-67% (w/w) protein source material, at least 15% (w/w) scrubber, 3%-15% (w/w) moisture; and at least 3% (w/w) humectant; the composition having a crumbs creation capability of 15 or less, and a hardness of 400 N or less. In some embodiments, the humectant is selected from the group consisting of glycerine, a starch hydrolysate, propylene glycol, and any combination thereof. Preferably, the humectant is present at about 3-15% (w/w) of the composition. In some embodiments, the composition further comprises a flavor enhancer. In some embodiments having a flavor enhancer, the flavor enhancer is preferably a poultry liver digest. In some embodiments, at least a portion of the protein source material is selected from the group consisting of wheat gluten, gelatin, caseinate, and any combination thereof. In some embodiments, at least a portion of the protein source material is selected from the group consisting of: wheat gluten or caseinate, and; gelatin. In some embodiments, the scrubber is selected from the group consisting of toasted or precooked cereal, ground cereal, broken cereal, cereal bran, microcrystalline cellulose, cellulose powder, and any combination thereof. In some embodiments, the average particle size of the toasted or precooked cereal is between 2 mm and 10 mm, the average particle size of the ground cereal is between 0.3 mm and 2 mm, the average particle size of the broken cereal is between 0.3 mm and 2 mm, the average particle size of the cereal bran is between 0.3 mm and 2 mm, and the average particle size of the microcrystalline cellulose is between 50 microns and 200 microns. Preferably, at least a portion of said scrubber is selected from the group consisting of toasted or precooked cereal at 5%-20% (w/w) of the composition, ground cereal or broken cereal at 5%-20% (w/w) of the composition, cereal bran at 2%-10% (w/w) of the composition, microcrystalline cellulose or cellulose powder or a combination of microcrystalline cellulose and cellulose powder at 0.2%-2% (w/w) of the composition; and, any combination thereof. More preferably, at least a portion of said scrubber is ground cereal or broken cereal at 5%-20% (w/w) of the composition, ground cereal or broken cereal at 5%-20% (w/w) of the composition or cereal bran at 2%-10% (w/w) of the composition; and, microcrystalline cellulose or cellulose powder or a combination of microcrystalline cellulose and cellulose powder at 0.2%-2% (w/w) of the composition. In some embodiments, the composition further comprises a processed carbohydrate. In some embodiments, the composition further comprises a salt scrubber. In some embodiments wherein the composition further comprises a salt scrubber, the salt scrubber is selected from the group consisting of calcium carbonate, dicalcium phosphate, titanium dioxide, and any combination thereof. In some embodiments, the average particle size of the calcium carbonate is between 200 microns and 700 microns, and the average particle size of the dicalcium phosphate is between 0.02 mm and 2 mm. In some embodiments, the composition further comprises a component selected from the group consisting of: an oral care component; a nutritional supplement; a process aid; a preservative; and, any combination thereof. Preferably the composition further comprises fat. In preferred embodiments, the composition has a crumbs creation capability of 9 or less, and a hardness of 230 N-300 N.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is illustrates a comparison of CCC values for two compositions of the present invention and that of an existing product.

FIG. 2 is compares the composition of the present invention to existing products for the force required for penetration and braking of product.

### DETAILED DESCRIPTION OF THE INVENTION

As used herein, “a” or “an” means one or more. Unless otherwise indicated, the singular contains the plural and the plural contains the singular.

As used herein, the term “scrubber” is defined as Grains, particles, or particulates that provide mechanical tooth cleaning when added to the matrix of the described pet chew invention.

As used herein, the term “crumb creation capacity” is a parameter that measures the percentage of crumbs that are generated when a food is broken from a bigger size to smaller sizes. The crumb creation capacity is also referred to herein as “CCC”.

The following provides a detailed description of a canine dental chew that addresses the current problems in the market. This includes proven modes of action for oral care efficacy, safety profile, nutritionally complete and balanced profile and a highly palatable product that will ensure no difficulty in administering.

The inventors have developed a canine dental chew composition that has the correct properties to balance safety and texture (tension between hardness and crumble), bite elasticity (for tooth contact time), provides multiple “scrubber” sizes to support tooth cleaning with a range of average particle sizes, and has the surprising result of palatability improvement with nutritional balance. The composition optimizes two important parameters for dental care efficacy of the canine dental chew. One of these is the crumb creation capacity (CCC), which is a measure of the tendency of the composition to form crumbs when it is broken from a larger size to a smaller size as when the composition is chewed by a dog. The other parameter is the hardness of the composition. The goal is to provide a composition with a matrix of scrubbers of different average particle sizes to clean the teeth. When the proper balance is struck, the composition can access the small spaces between teeth, and at the same time, be useful to clean the larger surface areas of an animal's teeth.

The composition comprises a protein source material that provides tough and chewy texture and a bonding agent for large and small particle scrubbers. It also provides the required hardness in the food product. Additionally, the composition comprises scrubbers with rough and abrasive surface textures and rough and abrasive edges, yet are easy to digest. Other, finer particle scrubbers may be used which act like a scour to clean teeth. The composition also comprises water and humectant as texturizers. Although any humectant can be used, a preferred example is glycerine.

Non-limiting examples of the protein source material include wheat gluten, gelatin, and caseinate, although other substitutes may be used provided they result in a product with proper CCC and hardness. The protein source material is preferably between 25% and 67%, more preferably between 25% and 50%, and most preferably 25% to 40% of the final composition by weight. When wheat gluten is used it is preferably at 15%-50%, more preferably 18% 40%, and most preferably 20%-30% by weight of the final composition. When gelatin is used it is preferably at 5%-20%, more preferably 5% to 15%, and most preferably 6% to 12% by weight of the final composition. When sodium caseinate is used it is preferably at 2%-20%, more preferably 3% to 15%, and most preferably 3% to 10%. by weight of the final composition. Any combination of these may be used, however, because of the similar behavior of wheat gluten or caseinate, it is preferable to use one or the other or both, in combination with gelatin.

Non-limiting examples of the scrubbers useful in the present composition include toasted cereal, ground cereal, cereal bran, microcrystalline cellulose, and cellulose powder, although other substitutes may be used provided they possess the proper roughness and abrasiveness and result in a product with proper CCC and hardness. Preferably, when toasted cereal is used, it is at 5%-20% (w/w) of the composition; when ground cereal is used, it is at 5%-20% (w/w) of the composition; when cereal bran is used, it is at 2%-10% (w/w) of the composition, and when microcrystalline cellulose or cellulose powder or a combination of microcrystalline cellulose and cellulose powder are used, they are at 0.2%-2% (w/w) of the composition. Specific examples of useful scrubbers include, but are not limited to, 1) toasted or precooked whole rice, toasted or precooked whole wheat, toasted or precooked sorghum, toasted or precooked millet, and toasted or precooked barley as non-limiting examples of toasted cereals; 2) ground rice, ground wheat, ground barley, ground corn, broken rice, broken wheat, broken barley, ground sorghum, ground millet, and broken corn as non-limiting examples of ground cereals; 3) oat bran, wheat bran, and rice hulls, as non-limiting examples of cereal bran. Non-limiting examples of humectants include glycerine (the preferred humectant), starch hydrolysates, and propylene glycol, although other substitutes may be used provided they result in a product with proper CCC and hardness.

Because the scrubber is intimately involved in cleaning the teeth via an abrasive action, the average particle size of this component is related to the CCC and is one way to insure that the final product has the right CCC. Preferably, the average particle size of the toasted cereal is between 2 mm and 10 mm, the average particle size of the ground cereal is between 0.3 mm and 2 mm, the average particle size of the broken cereal is between 0.3 mm and 2 mm, the average particle size of the cereal bran is between 0.3 mm and 2 mm, and the average particle size of the microcrystalline cellulose is between 90 microns and 100 microns.

In preferred embodiments, there is at least one of the medium-to-large particle cereal materials and one of the small particle cellulose materials. Most preferably, there is at least one large-particle toasted cereal, at least one medium-particle ground, broken or cereal bran and at least one small-particle cellulose material. In this way, the preferred composition comprises a large size particle material to clean the surfaces of teeth, a medium size particle to clean between teeth and small size particles to clean small interstices and the gum line.

The canine chew composition may also comprise a processed carbohydrate which can act as a major matrix of the product. The processed carbohydrates are typically heat treated, precooked, pregelatinized, or toasted starches. Non-starch carbohydrates may also be used. Examples of starches include wheat, rice, corn, tapioca, potato, barley, sorghum, millet, and flours thereof, etc. The heat treatment or cooking is preferred because it enhances gelatinization and binding action in the final product. The processed carbohydrate is preferably 0%-30%, more preferably 10% to 25%, and most preferably 12% to 20% by weight of the final composition, when used.

In addition to the scrubbers described above, the canine chew composition may comprise one or more salt scrubbers. These fine particle scrubbers act like a scour to clean teeth. Non-limiting examples of salt scrubbers include calcium carbonate, dicalcium phosphate, titanium dioxide, although other substitutes may be used provided they result in a product with proper CCC and hardness. Preferably, when calcium carbonate is used, it is at 0.5%-3% (w/w) of the composition; when dicalcium phosphate is used, it is at 0.5%-3% (w/w) of the composition; when titanium dioxide is used, it is at 0.02%-0.1% (w/w) of the composition. Preferably, when calcium carbonate is used, it has average particle size of between 200 and 700 microns; when dicalcium phosphate is used, it has an average particle size of between 0.2 mm and 2 mm.

The canine dental chew composition may comprise other components, including, but not limited to, an oral care component, a nutrition supplement, a process aid, a preservative; or any combination of the foregoing. Non-limiting examples of oral care components include monophosphate, triphosphate, polyphosphate, protein-bound zinc salts, amino acid-bound zinc salts, and any combination thereof. Non-limiting examples of nutritional supplements include sodium chloride, potassium chloride, choline chloride, a vitamin and mineral premix, and any combination thereof. Non-limiting examples of process aids include monoglyceride, calcium stearate, water, and any combination thereof. Non-limiting examples of preservatives include potassium sorbates, sulfates, water binders, and antioxidants. When any phosphate (mono, tri, or poly) is present, it is preferably present at about 0.4% to 0.8% (w/w) of the composition; when protein- or amino acid-bound zinc salts is present, it is preferably present at about 0.1% to 0.5% (w/w) of the composition, when sodium chloride is present, it is preferably present at about 0.2% to 0.8% (w/w) of the composition, when potassium chloride is present, it is preferably present at about 0.2% to 0.9% (w/w) of the composition, when choline chloride is present, it is preferably present at about 0.1% to 0.5% (w/w) of the composition, when vitamin and mineral premix is present, it is present at about 1.0% to 3% (w/w) of the composition, when monoglyceride is present, it is preferably present at about 1.0% to 5% (w/w) of the composition, when calcium stearate is present, it is preferably present at about 0.5% to 1.5% (w/w) of the composition, and when sorbates, sulfates, water binders, and antioxidants are present, they are preferably present at about 0.1% to 0.5% (w/w) of the composition.

The composition may also comprise fat for flavor and a source of essential fatty acids. Preferably, the fat is present at 0.2%-5% (w/w) of the composition. Non-limiting examples of fat include vegetable oil, poultry fat, tallow, and various combinations of these and other fats.

Various flavor enhancers may also be added to the composition. These components may be used to improve palatability. Preferably, poultry liver digest if used as a flavor enhancer for the canine dental chew, however, other substitutes, such as other animal proteins or simulated flavors may be used. Although the flavor enhancer can be present at any level, the preferred range is 2% (w/w) to 6% (w/w) of the composition.

In a preferred embodiment, the canine dental chew comprises the following weight percentages: 25% wheat gluten, 7.4% gelatin, 3.7% sodium caseinate, 3.6% poultry liver digest, 19.0% heat treated wheat four, 10.0% toasted whole rice, 6.0% ground rice, 3.5% oat bran, 0.3% microcrystalline cellulose, 1.3% calcium carbonate, 0.6% dicalcium phosphate, 0.04% titanium dioxide, 7.0% glycerine, 0.5% vegetable oil, 0.6% sodium tri-poly phosphate, 0.1% zinc sulfate, 0.5% sodium chloride, 0.7% potassium chloride, 0.2% choline chloride, 1.8% vitamin/mineral premix, 2.0% monoglyceride, 0.9% calcium stearate, 0.2% potassium sorbate, and 6.0% water.

As described above, the manner in which the dental chew disintegrates upon chewing affects its performance as an oral care item. An important parameter in this regard is the Crumb Creation Capacity (CCC) of the product. The following methodology can be used for testing the CCC value of the canine dental chew of the present invention.

In using the product, the pet bites the product, chews and swallows it. During this process, crumbs may be created. This test mimics the “crumbling” which occurs when a pet chews a food product. In this test, big samples are cut into small chunks (about 2 cm in each dimension). The chunks are put in the grinder (in specially defined rough mode). This process simulates the pet's “chewing and swallowing”. The percent of small particle size that can pass a certain sieve (e.g. Sieve US Size #10 (2 mm), or #20 (0.85 mm)) is used to represent the CCC value of the sample. The higher the percent, the higher percent of crumbs can be generated during biting and eating. The equipment used is a grinder, for example, Grinding Mill Model 4E, Straub Company. The sieves are used with a Pan RoTap machine, or suitable substitute.

Procedure
1. Obtain sieves US Size #10, #20 and Pan. Ensure all are clean, dry and free of foreign matter. Record their weights.
2. Cut samples into chunks with around 2 cm in each dimension.

Note that samples with particle sizes less than this size do not need to be cut.
3. Adjust the grinder into a rough model, try some samples to make sure that the big particle size after grinding is about 5-8 mm. Record the position of the two grinding plates and use the same mode each time.
4. Weigh 60-80 gram samples (cut) and grind them.
5. Arrange the sieves in the sequence of #10, #20, and Pan (From top to the bottom). Transfer all ground solids into the Sieve #10.

Place the stacked sieves in the RoTap machine. Pour the sample onto the top screen. Remove all sample from the sample cup. Place the lid on the top screen with the cork sticking up. Ensure that the hammer height is set to 1 5/16±⅙ inches. Lower the hammer onto the cork. Test should run for 10 minutes.
6. Weight each sieve (including samples) and calculate the percentage of samples on each particle size of the samples.
7. Particles that can pass through U.S. Sieve #10 and #20 have particles size of“<2 mm” and “<0.85 mm”, respectively. The percentage of these certain particles represents the Crumbs Creation Capability of the samples. The percentage of material that passes through Sieve #10 and #20 relative to the original sample is the CCC. Repeat testing for accuracy a minimum of 5 times per sample.

The compositions and particles sizes of the raw materials and final product may be changed so long as the final product is within the CCC and hardness limitations specified herein. The following raw material particle sizes were tested and shown to produce a product with the proper CCC value. While this provides some useful examples of suitable raw material properties, it should be understood that the invention is not so limited and other raw material may be used.

Whole Toasted Rice

| | Density | | Length | Width | Height |
|---|---|---|---|---|---|
| | (g/ml) | % Moisture | (mm) | (mm) | (mm) |
| Toasted Long Rice | 0.82 | 9.42 | 6.5 | 2.1 | 1.66 |
| STDEV | | | 0.5 | 0.11 | 0.08 |

Ground Rice

| U.S. Standard Sieve | Percent Retained |
|---|---|
| Retained on U.S. #10 (2.00 mm/2,000 microns) | 0% |
| Retained on U.S. #16 (1.18 mm/1,180 microns) | 55-65% |
| Retained on U.S. #20 (0.85 mm/850 microns) | 22-28% |
| Retained on U.S. #30 (0.60 mm/600 microns) | 8-12% |
| Through a U.S. #30 (0.60 mm/600 microns) | 12% (max.) |

Oat Bran

| | | |
|---|---|---|
| U.S. Standard Sieve # | % Retained | % Through |

| | | |
|---|---|---|
| #10 (2.00 mm/2,000 microns) | 0 | 100 |
| #16 (1.18 mm/1,180 microns) | 40 | 60 |
| #20 (0.85 mm/850 microns) | 18 | 42 |
| #25 (0.71 mm/710 microns) | 17 | 24 |
| #35 (0.5 mm/350 microns) | 19 | 6 |

Feeding trials were performed compared three formulations of the dental chew of the present invention with the prior art Greenies. The results provided below demonstrate a palatability advantage of the present invention in addition to it improved dental care properties

FEEDING TRIAL SUMMARY: PERFORMANCE ORAL SNACK VS. GREENIES
REGULAR

| ONL | | First Product | First | | |
|---|---|---|---|---|---|
| Trial | Products Tested | Approached | Product | Consumption | |
| No.* | Against Greenies | (%) | Tasted (%) | Ratio (%) | Comments |
| 05-116 | Formulation #1 | 47.5 vs. 52.5 | 90.0 vs. 10.0 | 91.1 vs. 8.9 | Significant preference |
| | | | | | in favor of Formulation |
| | | | | | #1 (α = 0.05) |
| 05-119 | Formulation #2 | 52.5 vs. 47.7 | 100.0 vs. 0.0 | 93.5 vs. 6.5 | Significant preference |
| | | | | | in favor of Formulation |
| | | | | | #2 (α = 0.05) |
| 05-129 | Formulation #3 | 50.0 vs. 50.0 | 83.8 vs. 16.2 | 89.6 vs. 10.4 | Significant preference |
| | | | | | in favor of Formulation |
| | | | | | #3 (α = 0.05) |

*Each trial involved 20 adult dogs, and four days. The two test treats were offered concurrently to each dog on each day.

Final product hardness should be no more than 400 N. Preferably, the hardness should be 200 N-400 N, more preferably 230 N-300 N. Hardness is a measure of the force necessary to penetrate the sample. Although other instruments are available, hardness can be measured using a TA-HDi Texture Analyzer (Texture Technologies Corp., Scarsdale, N.Y.) equipped with a 100 kg load cell. A triple point bend rig equipped with a flat blade probe that has dimensions of 89 mm, 70 mm and 3 mm in length, width and thickness respectively was used provided by the Texture Technologies, can be used to measure force versus distance. This method resembles the biting and chewing of the test samples by dogs. The samples are tested as they are without any modification by positioning on the test rig such that the probe will contact the middle of the sample at a direction of a 90° angle while the sample is laying on its width.

The tests may be conducted at a room temperature of 25° C. on samples that are at least a day old. One of skill in the art realizes that the results from these tests will vary depending upon the conditions upon which the tests are preformed. Such conditions that may be altered include the temperature conditions and/or the age of the sample. For example, if the sample is 1 week old, 2 weeks old, three weeks old, one month old, two months old, or 6 months olds, the sample hardness increases with time. More preferably, the pet chew was tested one day after production through about four months. Thus, depending upon the age of the sample, those of skill in the art are aware that the hardness increases as a factor of time.

The following parameters were used in the penetration test for hardness of the samples:
Texture Meter: TA-HDi Texture AnalyserProbe: TA-8A
Test Mode & Option
   Measure Force in Compression
   Return to Start
Parameters:
   Pre-test Speed: 4.0 mm/s
   Test Speed: 1.0 mm/s
   Post-test Speed: 4.0 mm/s
   Distance: 7.0 mm
   Load Cell: 100 kg
Trigger:
   Type: Auto
   Stop Plot at: Target
   Auto Tare: ON

Data were collected using the Texture Expert software from Texture Technologies Corp. The result was the average of the values of at least three samples that were tested. The hardness (N) is defined as the amount of force needed to penetrate the product.

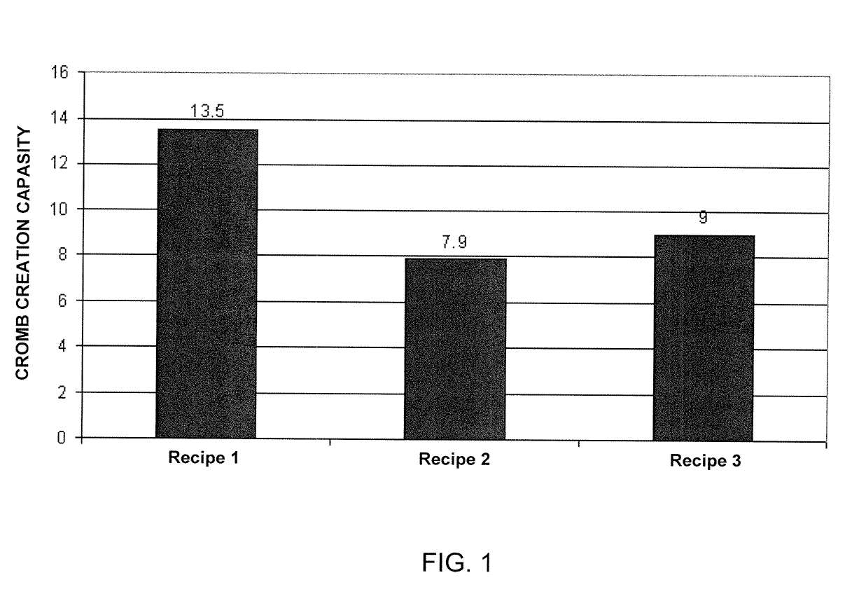

The composition of the present invention was compared to existing product. FIG. 1 illustrates CCC values for three products. Recipes 2 and 3 are compositions that are encompassed in the present invention. In addition to having a much poorer CCC value, the composition of Recipe 1, primarily a starch composition, has a protein content of 23% by weight.

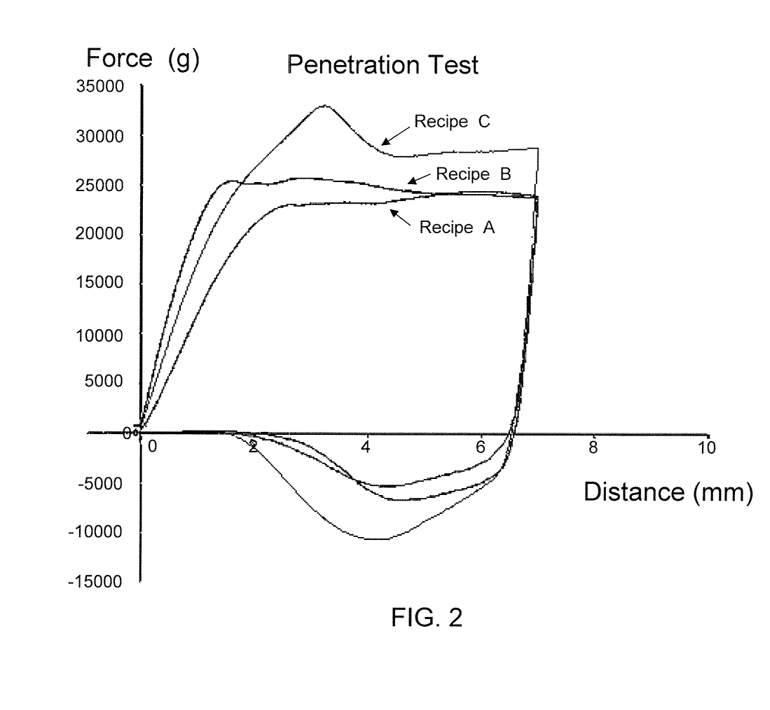

The composition of the present invention was compared to existing product for the force required for penetration and braking of product. The results are shown in FIG. 2. Recipe A is the composition of the present invention, while Recipe B and Recipe C are for existing compositions. Maximum biting forces for medium size dogs (10-20 kg BW) is between 400 N to 475 N. The penetration forces for the three compositions that are reported in the chart above are all below the biometric maximum biting forces, with Recipe C requiring the highest force to break. Being closer to maximum biting force, this may pose risks to more dogs in terms of difficulty breaking the bones and even teeth fracture. As can be seen, the composition of the present invention provides a product that breaks below maximum forces for medium size dogs.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the composition of matter, and methods described in the specification. As one of ordinary skill in the art will readily appreciate from the disclosure of the present invention, compositions of matter, methods, or steps, presently existing or later to be developed that perform substantially the same function or achieve substantially the same result as the corresponding embodiments described herein may be utilized according to the present invention. Accordingly, the appended claims are intended to include within their scope such processes, compositions of matter, methods, or steps. Although the invention has been disclosed with reference to its preferred embodiments, from reading this description those of skill in the art may appreciate changes and modifications that may be made which do not depart from the scope and spirit of the invention as described above and claimed hereafter.

What is claimed is:

1. A canine dental chew composition comprising:
25%-67% (w/w) protein source material, at least 15% (w/w) scrubber, 3%-15% (w/w) moisture; and at least 3% (w/w) humectant;
said composition having a crumbs creation capability of 15 or less, and a hardness of 400 N or less.

2. The canine dental chew composition of claim 1, wherein said humectant is selected from the group consisting of glycerine, a starch hydrolysate, propylene glycol, and any combination thereof.

3. The canine dental chew composition of claim 2, wherein said humectant is present at about 3%-15% (w/w) of the composition.

4. The canine dental chew composition of claim 1, further comprising a flavor enhancer.

5. The canine dental chew composition of claim 4, wherein the flavor enhancer is poultry liver digest.

6. The canine dental chew composition of claim 1, wherein at least a portion of said protein source material is selected from the group consisting of wheat gluten, gelatin, caseinate, and any combination thereof.

7. The canine dental chew composition of claim 6, wherein at least a portion of said protein source material is selected from the group consisting of:
wheat gluten or caseinate, and;
gelatin.

8. The canine dental chew composition of claim 1, wherein said scrubber is selected from the group consisting of toasted or precooked cereal, ground cereal, broken cereal, cereal bran, microcrystalline cellulose, cellulose powder, and any combination thereof.

9. The canine dental chew of claim 8, wherein the average particle size of said toasted or precooked cereal is between 2 mm and 10 mm, the average particle size of said ground cereal is between 0.3 mm and 2 mm, the average particle size of said broken cereal is between 0.3 mm and 2 mm, the average particle size of said cereal bran is between 0.3 mm and 2 mm, and the average particle size of said microcrystalline cellulose is between 50 microns and 200 microns.

10. The canine dental chew composition of claim 1, wherein at least a portion of said scrubber is selected from the group consisting of
toasted or precooked cereal at 5%-20% (w/w) of the composition,
ground cereal or broken cereal at 5%-20% (w/w) of the composition,
cereal bran at 2%-10% (w/w) of the composition,
microcrystalline cellulose or cellulose powder or a combination of microcrystalline cellulose and cellulose powder at 0.2%-2% (w/w) of the composition; and,
any combination thereof.

11. The canine dental chew composition of claim 10, wherein at least a portion of said scrubber is
ground cereal or broken cereal at 5%-20% (w/w) of the composition,
ground cereal or broken cereal at 5%-20% (w/w) of the composition or cereal bran at 2%-10% (w/w) of the composition; and,
microcrystalline cellulose or cellulose powder or a combination of microcrystalline cellulose and cellulose powder at 0.2%-2% (w/w) of the composition.

12. The canine dental chew composition of claim 1, further comprising a processed carbohydrate.

13. The canine dental chew composition of claim 1, further comprising a salt scrubber.

14. The canine dental chew composition of claim 13, wherein said salt scrubber is selected from the group consisting of calcium carbonate, dicalcium phosphate, titanium dioxide, and any combination thereof.

15. The canine dental chew of claim 14, wherein the average particle size of said calcium carbonate is between 200 microns and 700 microns, and the average particle size of said dicalcium phosphate is between 0.02 mm and 2 mm.

16. The canine dental chew composition of claim 1, further comprising a component selected from the group consisting of:
an oral care component;
a nutritional supplement;
a process aid;
a preservative; and,
any combination thereof.

17. The canine dental chew composition of claim 1, further comprising fat.

18. The canine dental chew composition of claim 1, having a crumbs creation capability of 9 or less, and a hardness of 230 N-300 N.
